(19) United States
(12) Patent Application Publication
(10) Pub. No.: US 2005/0143012 A1
(43) Pub. Date: Jun. 30, 2005

(54) Transmit power control method and radio arrangement

(75) Inventors: Jian Gu, Huangqi Nanhai Guangdong (CN); Seppo Hamalainen, Beijing (CN); Daqing Wang, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/809,676

(22) Filed: Mar. 26, 2004

(30) Foreign Application Priority Data
Dec. 31, 2003 (FI) 20031934

(51) Int. Cl. H04B 1/00

(52) U.S. Cl. 455/67.13

(57) ABSTRACT

A radio and a transmit power control method in a radio system supporting a use of coding blocks in communication between a base station and user equipment is disclosed. The method comprises producing a measured SIR (signal-to-interference ratio) value and compares the measured SIR value with the target SIR value. Accordingly, the method also comprises determining the quality of the received coding blocks. The method also comprising storing samples of the differences between the measured SIR value and the target SIR value. The method also comprises adjusting the target SIR value based on the values of the samples of differences between the measured SIR value and the target SIR value and the quality of the received coding block. The method also comprises providing a transmit power control command based on the adjusted target SIR value to the user equipment.

### FIELD

The invention relates to a transmit power control method and to a radio arrangement.

### BACKGROUND

In some radio systems, such as in wireless CDMA (Code Division Multiple Access) communications systems, fast closed loop power control is used to overcome the negative effects caused by slow fading and partial negative effects caused by fast fading. The fast closed loop power control comprises inner and outer loop power control. The outer loop power control sets a SIR (signal-to-interference ratio) target, while the inner loop power control determines the command of increasing or decreasing the transmit power. A SIR is a ratio of the power of the required signal to that of interference. The values of the SIR target and the received/measured SIR are used in determining the power control commands for increasing or decreasing the transmit power. The SIR target may be a fixed or a dynamic value. The dynamic SIR target is advantageous over the fixed one. The method of setting a SIR target is crucial to the system performance. A good method of setting a SIR target reduces the transmit power and keeps the quality of the communication in a given level and thus increases the capacity of interference-limited wireless communications systems.

Soft handover is another important feature of radio systems. User equipment under soft handover starts to communicate with a new base station and keeps the connection with the previous base station(s) when the user equipment moves to the boundary area of two or more base stations. Thus, the user equipment simultaneously communicates with two or more base stations during soft handover.

During soft handover, the power of the user equipment is controlled by power control commands from all the base stations with which the user equipment is communicating. Only when the power control commands from all the base stations are all detected by the user equipment as ‘UP’ ones does the user equipment increase its transmitter power. Otherwise, the user equipment reduces its transmitter power. The mechanism of uplink inner loop power control at each BTS (Base Transceiver Station) or Node B is used under soft handover. For outer loop power control of the base stations under soft handover different systems adopt different methods. In some systems, for example, all the base stations in an active set of the user equipment have the same SIR target for the user equipment. An RNC (Radio Network Controller) sets the target for all base stations in the active set of the user equipment based on the combined quality of received frames when the user equipment is under soft handover. However, in some systems, the outer loop power control is carried out independently at each BTS during soft handover and each BTS sets its independent SIR target based on the quality of received frames at the BTS.

It is known that the uplink soft handover brings diversity and thus improves the system performance. Because the diversity brought by uplink soft handover is selection combining instead of maximum ratio combining diversity, the error rate performance of each link directly determines the error rate performance after combining. Therefore, the SIR target of each base station directly determines the performance of the radio system.

In some systems, the uplink outer loop power control is centralizedly performed at the RNC, which brings more signalling between the RNC and the Node B and also long feedback delays of the SIR target, the feedback delay being typically hundreds of milliseconds. Under uplink soft handover, outer loop power control is carried out at the RNC according to a method described in an article by A. Sampath, P. Sarath Kumar, J. M. Holtzman: On setting reverse link target SIR in a CDMA system published in the IEEE 47^{th} Vehicular Technology Conference 1997.

A problem occurs in systems where outer loop power control is distributed in each base station in the following situation. It is assumed that user equipment is communicating with two base stations. The sum of the path loss and shadow between the user equipment and the first base station is Δ_{slow-fading} dB smaller than that between the user equipment and the second base station for a relatively long time, typically hundreds of milliseconds. The symbol Δ_{slow-fading} is a slow fading difference between two links with the two base stations. The first base station is said to be a primary base station, while the second base station is a secondary base station. The first base station receives signals with higher SIR values and obtains fewer error frames after decoding while the secondary base station receives more error frames after decoding. As a result, the SIR target of the secondary base station increases quickly and may always be near the predetermined maximum SIR target value. Thus, the received SIR value at the secondary base station is seldom above the SIR target value set by the outer loop power control and the secondary base station seldom sends a ‘DOWN’ command to the user equipment. Thus, the power control commands sent by the second base station may be of no use.

When the secondary base station becomes a primary base station, it uses a SIR target value that is substantially higher than necessary. It takes some time to adjust the SIR target value to a proper level. This is a problem especially in the known outer loop power control method in which small step sizes are used to adjust downwards. During the time the SIR target value is being adjusted, the user equipment requests too high power. This further leads to capacity degradation. Also, when user equipment communicates simultaneously with two or more base stations, the performance of the system will degrade due to one or more useless power control channels.

### BRIEF DESCRIPTION OF THE INVENTION

According to an embodiment of the invention, there is provided a transmit power control method in a radio system supporting a use of coding blocks in communication between a base station and user equipment, the method comprising receiving coding blocks in at least one base station having a target SIR (signal-to-interference ratio) value, decoding the received coding blocks by the base station, measuring a SIR (signal-to-interference ratio) value, comparing, by the base station, the measured SIR value with the target SIR value of the base station. The method includes the steps of determining the quality of a received coding block, storing samples of differences between the measured SIR value and the target SIR value, adjusting the target SIR value based on the values of the samples of the differences between the measured SIR value and the target SIR value and the quality of the received coding block, and providing a transmit power control command based on the adjusted target SIR value to the user equipment.

According to another embodiment of the invention, there is provided a radio arrangement of transmit power control, the radio arrangement being configured to use coding blocks in communication between a transceiver and a receiver, and to use a target SIR (signal-to-interference ratio) value in transmit power control. The radio arrangement comprises decoding means for decoding a received coding block, measuring a SIR (signal-to-interference ratio) value and comparing means for comparing the measured SIR value with the target SIR value. The radio arrangement further comprises means for determining the quality of the received coding block, storing means for storing samples of differences between the measured SIR value and the target SIR value, adjusting means for adjusting the target SIR value based on the values of the samples of the differences between the measured SIR value and the target SIR value and the quality of the received coding block, and means for providing a transmit power control command based on the adjusted target SIR value.

The method and radio arrangement of the invention provide several advantages. For example, the power control of the radio arrangement is improved. Another advantage is that the transmit power of the user equipment is reduced timely and the communication quality is kept at a target level. Thus, the capacity of the radio arrangement supporting uplink fast closed loop power control and uplink soft handover is increased.

### LIST OF DRAWINGS

In the following, the invention will be described in greater detail with reference to the preferred embodiments and the accompanying drawings, in which

FIG. 1 is a simplified block diagram illustrating the structure of a radio system which may be employed in an embodiment of the invention;

FIG. 2 shows a simplified outline of an embodiment of the present invention;

FIG. 3 shows a time evolution of parameters associated with data transfer; and

FIG. 4 shows an example of the method of transmit power control in a radio arrangement according to an embodiment of the invention.

### DESCRIPTION OF EMBODIMENTS

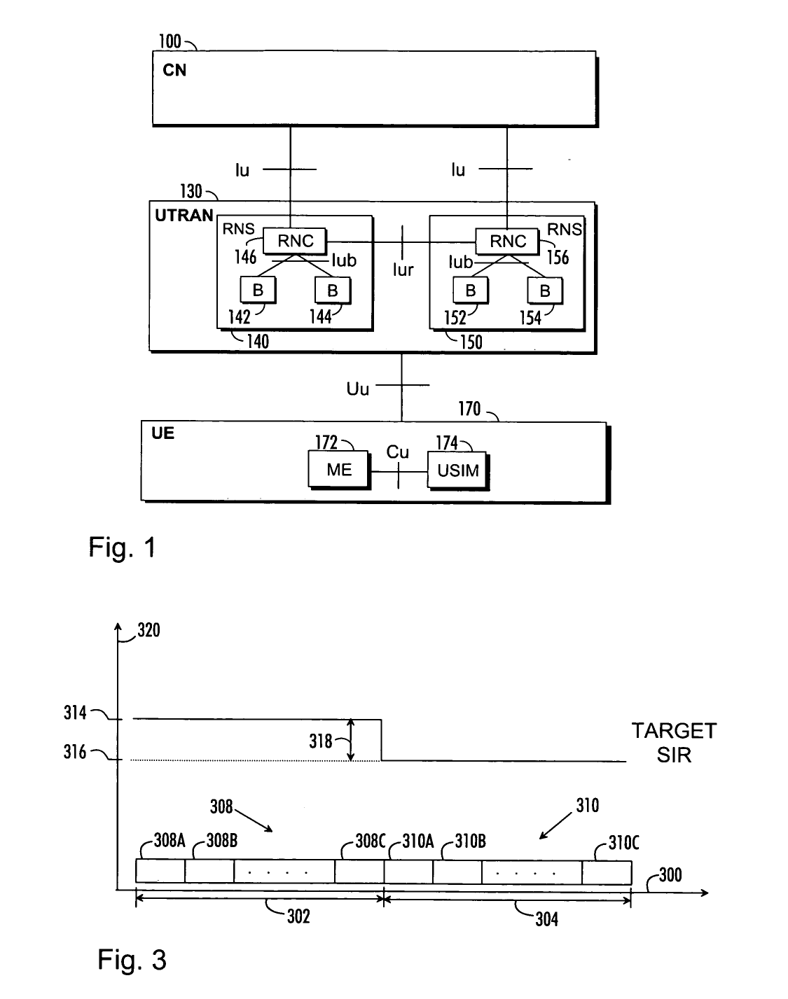

FIG. 1 illustrates an example of a radio system to which the embodiments of the invention can be applied. A radio system in FIG. 1, known at least as UTRAN [UMTS (Universal Mobile Telecommunications System) Terrestrial Radio Access Network] 130, is taken as an example. The UTRAN belongs to the third generation and is implemented with WCDMA (Wideband Code Division Multiple Access) technology. The solution is not limited to a WCDMA radio interface but applications exist which are implemented with cdma2000, MC-CDMA (Multi-Carrier Code Division Multiple Access) or OF-DMA (Orthogonal Frequency Division Multiple Access) technologies without restricting the invention to the above-mentioned technologies.

FIG. 1 is a simplified block diagram which shows the most important parts of a radio system and the interfaces between them at a network-element level. The structure and functions of the network elements are not de-scribed in detail, because they are generally known.

The main parts of a radio system are a core network (CN) 100, a radio access network 130 and user equipment (UE) 170. The term UTRAN is short for UMTS Terrestrial Radio Access Network, i.e. the radio access net-work 130 belongs to the third generation and is implemented by wideband code division multiple access (WCDMA) technology. The main elements of the UTRAN are radio network controller (RNC) 146, 156, Node Bs 142, 144, 152, 154 and user equipment 170. The UTRAN is attached to the existing GSM core network 100 via an interface called Iu. This interface is supported by the RNC 146, 156, which manages a set of base stations called Node Bs 142, 144, 152, 154 through interfaces called lub. The UTRAN is largely autonomous from the core network 100 since the RNCs 146, 156 are interconnected by the lur interface.

On a general level, the radio system can also be defined to comprise user equipment also known as a subscriber terminal and a mobile phone, for instance, and a network part which comprises the fixed infrastructure of the radio system, i.e. the core network, radio access network and base station system.

From the point of view of Node B 142, 144, 152, 154, i.e. a base station, there is one controlling RNC 146, 156 where its Iub interface terminates. The controlling RNC 146, 156 also takes care of admission control for new mobiles or services attempting to use the Node B 142, 144, 152, 154. The controlling RNC 146, 156 and its Node Bs 142, 144, 152, 154 form an RNS (Radio Network Subsystem) 140, 150.

The user equipment 170 may comprise mobile equipment (ME) 172 and a UMTS subscriber identity module (USIM) 174. The USIM 174 contains information related to the user and information related to information security in particular, for instance, an encryption algorithm.

In UMTS networks, the user equipment 170 can be simultaneously connected to a plurality of Node Bs in the occurrence of soft handover.

From point of view of the user equipment 170 there is a serving RNC 146, 156 that terminates the mobile link layer communications. From the point of view of the CN 100, the serving RNC 146, 156 terminates the Iu for this user equipment 170. The serving RNC 146, 156 also takes care of admission control for new mobiles or services attempting to use the CN 100 over its Iu interface.

In the UMTS, the most important interfaces between network elements are the Iu interface between the CU 100 and the radio access network 130, which is divided into the interface IuCS on the circuit-switched side and the interface IuPS on the packet-switched side, and the Uu interface between the radio access network and the user equipment.

In the prior art solutions, under uplink soft handover, outer loop power control in some systems is carried out at the RNC 146, 156. It is assumed that the target FER (Frame Error Rate) of the connection is FER_{target}. A FER is a ratio of the number of erroneous frames to the total number of frames transmitted in a given time interval. When a frame is in error after having been combined at the RNC, the SIR target increases by Δ_{OLPC-UP}, the symbol Δ_{OLPC-UP} denoting SIR target up step of outer loop power control. Otherwise, the SIR target decreases by Δ_{OLPC-DOWN}, where Δ_{OLPC-DOWN} denotes SIR target down step of outer loop power control. The RNC then feedbacks the SIR target to Node B. The Δ_{OLPC-DOWN} may be calculated by dividing the value of the SIR target up step of outer loop power control by the inverse value of the FER minus one by using formula (1):

$${Δ}_{OLPC\_DOWN} = \frac{{Δ}_{OLPC\_UP}}{1 / {FER}_{target} - 1} \qquad ( 1 )$$

where:
Δ_{OLPC-DOWN} is the SIR target down step of outer loop power control,
Δ_{OLPC-UP} is the SIR target up step of outer loop power control, and
FER_{target} is the target frame error rate.

In prior art solutions, the uplink outer loop power control of some systems may be carried out in the following way during uplink soft handover. It is assumed that the target FER of the connection is FER_{target} and the user equip-ment is connecting m base stations. Each BTS has its independent SIR target and outer loop power control. When a frame is decoded in error at the BTS, the SIR target of the BTS increases by Δ_{OLPC-UP}. Otherwise, the SIR target of the BTS decreases by Δ_{OLPC-DOWN}, where the Δ_{OLPC-DOWN} may be calculated by dividing the value of the SIR target up step of outer loop power control by the inverse value of the m^{th} root of FER target minus one by using formula (2):

$${Δ}_{OLPC\_DOWN} = \frac{{Δ}_{OLPC\_UP}}{1 / \sqrt[m]{{FER}_{target}} - 1} \qquad ( 2 )$$

where:
m is the number of base stations with which the user equipment is communicating.

In an embodiment of the invention, the balance between the target SIR values from the outer-loop power control distributed in the cells is kept by interfering in the steps of prior art when for a period the target SIR value is much larger than the measured SIR target.

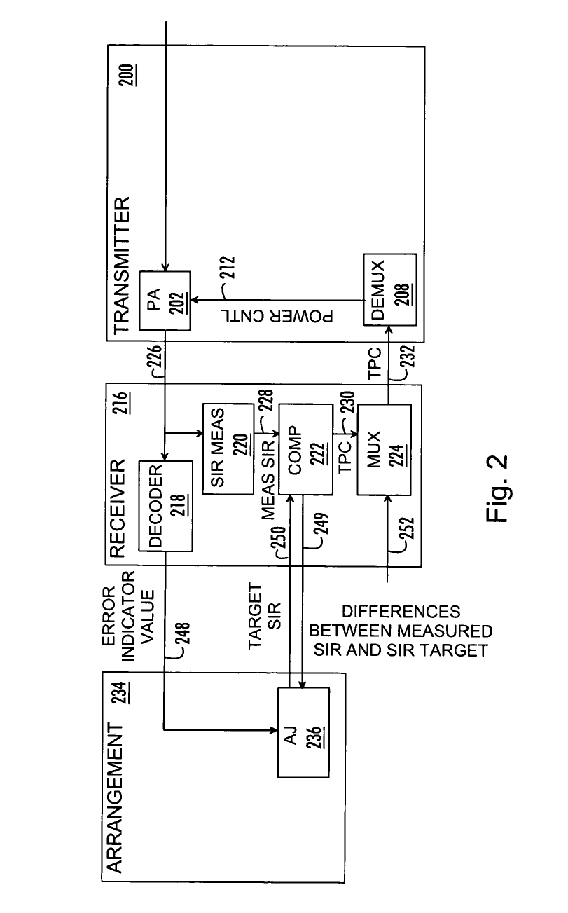

FIG. 2 shows a simplified outline of an embodiment of the present invention. In FIG. 2, a transmitter 200 transmits a dedicated channel 226, which is received by a receiver 216. The dedicated channel is typically dedicated to a single transmitter-receiver pair, and may be separated from other radio channels by a specific channelization coding. The dedicated channel may further be associated with a specific antenna beam, which may be a transmit antenna beam or a receive antenna beam, depending on the antenna configuration of the receiver 216 and the transmitter 200.

In the UTRAN, the dedicated channel 226 may be an uplink dedicated physical channel, such as a DPDCH (Dedicated Physical Data Channel), and DPCCH (Dedicated Physical Control Channel), for example. In the UTRAN, the dedicated channel 226 may be a downlink dedicated physical channel, such as a DPCH (Downlink Dedicated Physical Channel). In an embodiment of the invention, the transmitter 200 may be user equipment 170, and the receiver 216 may be a base station 142, for example.

The dedicated channel 226 is received by the receiver 216, which measures a SIR (Signal-to-interference Ratio) value in a SIR measurement unit 220. The SIR value measurement and the SIR measurement unit 220 are known to one skilled in the art. The SIR value characterizes the signal quality obtained with a direct measurement.

In an embodiment of the invention, the arrangement 234 further includes an adjusting unit 236. A measured SIR value 228 is inputted from the SIR measurement unit 220 into a comparator unit 222, which compares the measured SIR value with a target SIR value 250 received from the adjusting unit 236. The target SIR value provides a reference SIR value for closed loop power control.

The comparator 222 provides differences between the measured SIR and the SIR target values 249 to the adjusting unit 236 and generates a transmit power control command 230 (TPC) based on the comparison and inputs the transmit power control command into a multiplexer 224. For example, if the measured SIR value is less than the target SIR value, the transmit power control command aims at increasing the transmit power. If the measured SIR value is more than the target SIR value, the transmit power control command aims at decreasing the transmit power.

The multiplexer 224 multiplexes the transmit power control command into a physical channel 232, such as the DPCH or uplink DPCCH, and provides the receiver 200 with the transmit power control command. The physical channel 232 may further transfer a payload signal 252 inputted into the multiplexer 224. The receiver 200 may include a de-multiplexer 208, which extracts the transmit power control command from the physical channel 232, and provides the power amplifier 202 with the transmit power control command 212.

The invention is not restricted to the presented example but may be applied to any power control mechanism that supports fast power control wherein a target SIR value is used as a reference value.

Coding blocks, such as frames, of the dedicated channel 226 may be decoded in a decoder 218. The decoder 218 may report an error indicator value 248 to the adjustment unit 236. The error indicator typically characterizes a quality of data transfer carried by the dedicated channel. The reliability indicator may be a result from a CRC (Cyclic Redundancy Check), estimated BER (Bit Error Rate), soft information, or E_{b}/N₀ (a ratio of the combined received energy per information bit to the noise power spectral density), E_{b}/N₀ (a ratio of the combined received energy per information bit to the effective noise power spectral density), for example. The error indicator value typically indicates erroneous or correct decoding of a coding block decoded in the decoder 218.

With reference to FIG. 3, let us consider an example of time evolution of parameters associated with data transfer. The x-axis 300 shows time in arbitrary scale. The y-axis 320 shows a target SIR in arbitrary scales.

Transmission of the dedicated channel 226 may be divided into a first TX time interval 302 and a second TX time interval 304. Further time intervals may exist, but they are not shown in FIG. 3.

A first coding block 308 is transmitted during the first TX time interval 302 and a second coding block 310 is transmitted during the second TX time interval 304. The second TX time interval 304 is transmitted before the first TX time interval 304.

A coding block 308, 310 may be a frame structure, such as a radio frame. In the UTRAN, for example, the duration of a TX time interval 302, 304 is typically a multiple of the duration of a 10 milliseconds radio frame.

The first coding block 308 and the second coding block 310 may be divided into time slots 308A, 308B, 308C and 310A, 310B, 310C, respectively. In the UTRAN, a coding block 308, 310 includes 15 time slots, each time slot corresponding to an inner loop power control period.

The adjusting unit 236 adjusts the target SIR 250 and inputs the target SIR 250 into the comparator 222. As a result, the inner loop of the closed-loop power control converges to a transmit power, thus enabling minimizing the multi-user interference effects and increasing the capacity of the telecommunications system. The adjusting unit 236 may be implemented with a computer and software, and required interfaces and connections to the receiver 216. The computer may include random access memory.

The equations and the quantities herein are typically expressed in dB units. However, it is clear to one skilled in the art to convert the equations into other units.

In an embodiment of the invention, the adjusting unit 236 adjusts the target SIR value to provide a required quality of the dedicated channel. The required quality may be a target FER (Frame Error Rate) or another quality measure characterizing the true quality of the data transfer. The adjusting unit 236 may, for example, include a look-up table including target SIR values for different required qualities of the dedicated channel. For example, there are target FER values FER_{target}=5% and FER_{target}=1% corresponding to the required quality of transmission of a video signal and transmission of an electric mail file. Therefore, there may be a look-up table for each target FER value, and as a result, the target SIR value is different in the two cases, thus leading to different transmit power requirements.

In an embodiment of the invention, the adjusting unit 236 estimates a change 318 in a required SIR with respect to a change from a second data rate 322 to the first data rate 306. The required SIR is defined, for example, by the target FER. The target SIR 314, which matches the first data rate 306, may be obtained by subtracting the change 318 in the required SIR from the target SIR 316, which matches the second data rate 322.

In an embodiment of the invention, the radio arrangement stores samples of differences between the measured SIR value and the target SIR value 249. Next, the adjusting unit 236 adjusts the target SIR value based on the values of the samples of the differences between the measured SIR value and the target SIR value 249 and the quality of a received coding block. Finally, a transmit power control command is provided based on the adjusted target SIR value. The arrangement 234 may be in the receiver 216, or it may be separate from the receiver 216.

In an embodiment of the invention, the adjustment unit 236 is configured to adjust the target SIR value by reducing the target SIR value by a predetermined down step when the decoding of the received coding block succeeds and the difference between the measured SIR value and the SIR target value is smaller than the threshold that is defined for the measured SIR value minus the target SIR value for the fraction of time slots of the coding blocks. Accordingly, the adjustment unit 236 may be configured to reduce the target SIR value by a predetermined down step when the decoding of the received coding block succeeds and the sum of the multiple differences between the measured SIR value and the target SIR value is smaller than the negative value threshold that is de-fined for the measured SIR value minus the target SIR value. The adjusted target SIR value is limited not to be smaller than a local minimum target SIR value.

In an embodiment, a target SIR value up step is added to the target SIR value when the decoding of the received coding block fails and the difference between the measured SIR value and the SIR target value is smaller than the threshold for the measured SIR value minus the target SIR value for the fraction of time slots of the coding blocks. Further, the adjustment unit 236 may be configured to add a target SIR value up step to the target SIR value when the decoding of the received coding block fails and the sum of the multiple differences between the measured SIR value and the target SIR value is smaller than the negative-value threshold that is defined for the measured SIR value minus the target SIR value. The target SIR value up step may be either negative, positive or zero. The adjusted target SIR value is limited not to be smaller than a local minimum target SIR value and not to be larger than a local maximum target SIR value.

In an embodiment of the invention, when the decoding of the received coding block succeeds, the adjustment unit 236 is configured to adjust the target SIR value by reducing the target SIR value by a predetermined down step of outer loop power control when the difference between the measured SIR value and the SIR target is larger than the threshold that is defined for the measured SIR value minus the target SIR value for the fraction of time slots of the coding blocks. Accordingly, the adjustment unit 236 may be configured to reduce a predetermined down step of outer loop power control from the target SIR value when the decoding of the received coding block succeeds and the sum of the multiple differences between the measured SIR value and the target SIR value is larger than the negative value threshold that is defined for the measured SIR value minus the target SIR value. The adjusted target SIR value is limited not to be smaller than a global minimum target SIR value.

In an embodiment, a target SIR up step of outer loop power control is added to the target SIR value when the decoding of the received coding block fails and the difference between the measured SIR value and the SIR target is larger than the threshold for the measured SIR value minus target SIR value for the fraction of time slots of the coding blocks. Further, the adjustment unit 236 may be configured to add a target SIR value up step to the target SIR value when the decoding of the received coding block fails and the sum of the multiple differences between the measured SIR value and target SIR value is larger than the negative value threshold that is defined for the measured SIR value minus the target SIR value. The adjusted target SIR value is limited not to be lar-ger than a global maximum target SIR value.

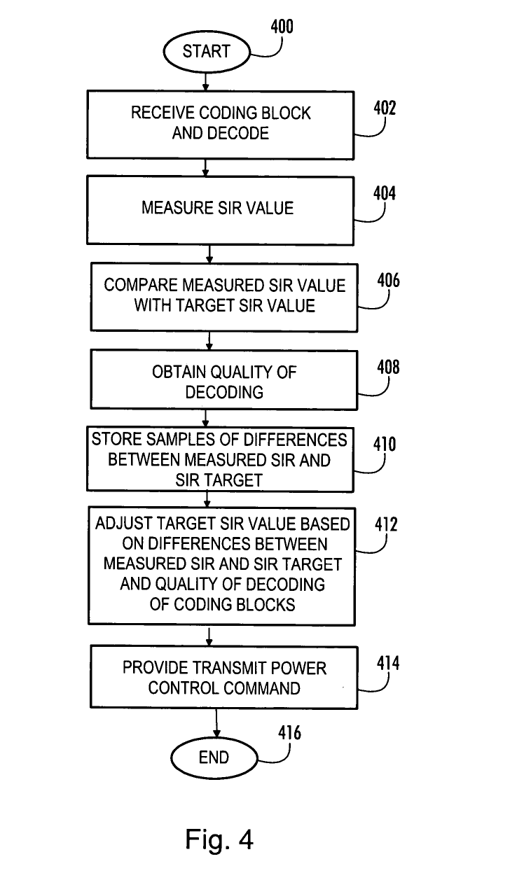

FIG. 4 shows an example of a method of transmit power control in a radio system. The method starts in 400. In 402, a coding block is received and decoded in at least one base station of the radio system, for example. In 404, the SIR value is measured. In 406, the measured SIR value is compared with the target SIR value of the base station. In 408, the quality of the received coding block is determined. Samples of differences between the measured SIR values and the target SIR values are stored in 410. In 412, the target SIR value of the base station is adjusted based on the stored differences between the measured SIR values and the target SIR values and on the quality of the coding blocks. Next, step 412 is next described in more detail.

Let us assume that a base station of the radio system is under an uplink soft handover situation. The base station compares the measured SIR value with the target SIR value and then stores samples, for example N samples, of differ-ences between the measured SIR values of the latest N power control groups (or slots) and the target SIR values of the latest N power control groups (or slots). N is a positive integer, a system parameter. Herein, SIR_{target}(i-1) and SIR_{target}(i) denote the target SIR values (in dB) for the (i-1)th and (i)th coding blocks at the base station, respectively. Each base station in the user equipment active set has its independent target SIR value, SIR_{target}(i), that is based on SIR_{target}(i-1), quality of the (i-J)th coding block and the values of the N samples Δ_{SIR}(n)dB, where n=1, . . . ,N. The embodiments of the invention may be divided into hard decision and soft decision ones. The hard-decision method may be implemented as follows.

Let us assume that K is the number of N samples, Δ_{SIR}(n), that satisfy a condition of Δ_{SIR}(n) being smaller than a threshold that is defined for the measured SIR value minus the target SIR value, t. We denote this in the following way: Δ_{SIR}(n)<t. When adjusting the target SIR value, it is first detected whether K is higher than or equal to the product of N and a fraction threshold of the slots, f, that is, whether K≧└N·f┘ and using the operator of └ ┘ results in the larger integral whose value is smaller than the processed real number. Let us assume that J-1 is the decoding delay whose value depends on the implementation of the decoder.
If K≧└N·f┘ and the (i-J)th coding block is decoded correctly, and SIR_{target}(i−1)−Δ₁≧SIR₁, it can be determined that SIR_{target}(i)=SIR_{target}(i−1)−Δ₁;
Else, if K≧└N·f┘ and the (i-J)th coding block is decoded correctly and SIR_{target}(i−1)−Δ₁<SIR₁, then SIR_{target}(i)=SIR₁;
Else, if K≧└N·f┘ and the (i-J)th coding block is decoded in error, and SIR_{target}_{_{—}}ₘₐₓ≧SIR_{target}(i−1)+Δ₂≧SIR₂, then SIR_{target}(i)=SIR_{target}(i−1)+Δ₂;
Else, if K≧└N·f┘ and the (i-J)th coding block is decoded in error and SIR_{target}(i−1)+Δ₂≧SIR_{target}_{_{—}}ₘₐₓ, then SIR_{target}(i)=SIR_{target}_{_{—}}ₘₐₓ;
Else, if K≧└N·f┘ and the (i-J)th coding block is decoded in error and SIR_{target}(i−1)+Δ₂<SIR₂, then SIR_{target}(i)=SIR₂;
Else, if K<└N·f┘ and the (i-J)th coding block is decoded in error and SIR_{target}(i−1)+Δ_{OLPC-UP}≦SIR_{target}_{_{—}}ₘₐₓ, then SIR_{target}(i)=SIR_{target}(i−1)+Δ_{OLPC-UP};
Else, if K<└N·f┘ and the (i-J)th coding block is decoded in error and SIR_{target}(i−1)+Δ_{OLPC-UP}≧SIR_{target}_{_{—}}ₘₐₓ, then SIR_{target}(i)=SIR_{target}_{_{—}}ₘₐₓ;
Else, if SIR_{target}(i−1)−Δ_{OLPC-DOWN}≧SIR_{target}_{_{—}}ₘᵢₙ, then SIR_{target}(i)=SIR_{target}(i−1)−Δ_{OLPC-DOWN};
Else, SIR_{target}(i)=SIR_{target}_{_{—}}ₘᵢₙ.

The parameters used in the above example are as follows:
Δ_{OLPC-UP} is a SIR target up step of outer loop power control,
Δ_{OLPC-DOWN} is a SIR target down step of outer loop power control,
SIR_{target}_{_{—}}ₘₐₓ is a global maximum SIR target value,
SIR_{target}_{_{—}}ₘᵢₙ is a global minimum SIR target value,
t is a threshold that is defined for the measured SIR value minus the target SIR value,
f is the fraction threshold of the slots in which the measured SIR value minus the target SIR value is smaller than the threshold, t,
SIR₁ is the local minimum target SIR value when the coding block is decoded correctly and the measured SIR value (in dB) is t dB smaller than the target SIR value (in dB) for the fraction f of slots,
SIR₂ is the local minimum target SIR value when the coding block is decoded in error and the measured SIR value (in dB) is t dB smaller than the target SIR value (in dB) for the fraction f of slots,
Δ₁ is the SIR target down step when the coding block is decoded correctly and the measured SIR value (in dB) is t dB smaller than the target SIR value (in dB) for the fraction f of slots,
Δ₂ is the SIR target up step when the coding block is decoded in error and the measured SIR value (in dB) is t dB smaller than the target SIR value (in dB) for the fraction f of slots.

The ranges of the given parameters may be as follows: t≦0, 1≧f≧0, Δ₁≧0, Δ_{OLPC-UP}>0, Δ_{OLPC-DOWN}>0, SIR_{target}_{_{—}}ₘₐₓ≧SIR₁≧SIR_{target}_{_{—}}ₘᵢₙ and SIR_{target}_{_{—}}ₘₐₓ≧SIR₂≧SIR_{target}_{_{—}}ₘᵢₙ. The range of Δ₂ is, for example, Δ_{OLPC-UP}≧Δ₂≧−Δ₁.

In an embodiment of the invention, when the coding block is decoded correctly and the measured SIR value is t dB smaller than the target SIR value for the fraction f of slots, the target SIR value is too high and the power of the soft handover user is controlled by another base station and the power control bits generated by this base station are of no use. Thus, the target SIR value should be reduced by the step Δ₁, which is larger than Δ_{OLPC-DOWN}.

In an embodiment of the invention, when the coding block is decoded in error and the measured SIR value is t dB smaller than the target SIR value for the fraction f of slots, it is uncertain whether or not the target SIR value is too high. Thus, the target SIR value may be updated by step Δ₂, which is either negative (progressive), positive (conservative) or zero (neutral). If step Δ₂ is zero, the target SIR value may be unchanged.

Next, an embodiment of the soft decision method is described. The soft-decision method uses the sum of Δ_{SIR}(n),

$${\sum }_{n = 1}^{N} {Δ}_{SIR} ( n ) ,$$

for adjusting the target SIR value.
If

$${\sum }_{n = 1}^{N} {Δ}_{SIR} ( n ) \leq t$$

and the (i-J)th coding block is decoded correctly, and SIR_{target}(i−1)−Δ₁≧SIR₁, it can be determined that SIR_{target}(i)=SIR_{target}(i−1)−Δ₁;
Else, if

$${\sum }_{n = 1}^{N} {Δ}_{SIR} ( n ) \leq t$$

and the (i-J)th coding block is decoded correctly and SIR_{target}(i−1)−Δ₁≦SIR₁, then SIR_{target}(i)=SIR₁;
Else, if

$${\sum }_{n = 1}^{N} {Δ}_{SIR} ( n ) \leq t$$

and the (i-J)th coding block is decoded in error, and SIR_{target}_{_{—}}ₘₐₓ≧SIR_{target}(i−1)+Δ₂≧SIR₂, then SIR_{target}(i)=SIR_{target}(i−1)+Δ₂;
Else, if

$${\sum }_{n = 1}^{N} {Δ}_{SIR} ( n ) \leq t$$

and the (i-J)th coding block is decoded in error and SIR_{target}(i−1)+Δ₂>SIR_{targe}_{_{—}}ₘₐₓ, then SIR_{target}(i)=SIR_{target}_{_{—}}ₘₐₓ;

Else, if

$${\sum }_{n = 1}^{N} {Δ}_{SIR} ( n ) \leq t$$

and the (i-J)th coding block is decoded in error and SIR_{target}(i−1)+Δ₂≦SIR₂, then SIR_{target}(i)=SIR₂;
Else, if

$${\sum }_{n = 1}^{N} {Δ}_{SIR} ( n ) > t$$

and the (i-J)th coding block is decoded in error and SIR_{target}(i−1)+Δ_{OLPC-UP}≦SIR_{target}_{_{—}}ₘₐₓ, then SIR_{target}(i)=SIR_{target}(i−1)+Δ_{OLPC-UP};
Else, if

$${\sum }_{n = 1}^{N} {Δ}_{SIR} ( n ) > t$$

and the (i-J)th coding block is decoded in error and SIR_{target}(i−1)+Δ_{OLPC-UP}>SIR_{target}_{_{—}}ₘₐₓ, then SIR_{target}(i)=SIR_{target}_{_{—}}ₘₐₓ;
Else, if SIR_{target}(i−1)-Δ_{OLPC-DOWN}≧SIR_{target}_{_{—}}ₘᵢₙ, then SIR_{target}(i) SIR_{target}(i−1)−Δ_{OLPC-DOWN};
Else, SIR_{target}(i)=SIR_{target}_{_{—}}ₘᵢₙ,

The parameters used in the above example are as follows:
Δ_{OLPC-UP} is a SIR target up step of outer loop power control,
Δ_{OLPC-DOWN} is a SIR target down step of outer loop power control,
SIR_{target}_{_{—}}ₘₐₓ is a global maximum SIR target value,
SIR_{target}_{_{—}}ₘᵢₙ is a global minimum SIR target value,
t is a threshold that is defined for the measured SIR value minus the target SIR value,
SIR₁ is the local minimum target SIR value when the coding block is decoded correctly and the sum of the N samples of the differences between the measured SIR value (in dB) and the target SIR value (in dB) is smaller than the negative-value threshold of t dB,
SIR₂ is the local minimum target SIR value when the coding block is decoded in error and the sum of the N samples of the differences between the measured SIR value (in dB) and the target SIR value (in dB) is smaller than the negative-value threshold of t dB,
Δ₁ is the SIR target down step when the coding block is decoded correctly and the sum of the N samples of the differences between the measured SIR value (in dB) and the target SIR value (in dB) is smaller than the negative-value threshold of t dB,
Δ₂ is the SIR target up step when the coding block is decoded in error and the sum of the N samples of the differences between the measured SIR value (in dB) and the target SIR value (in dB) is smaller than the negative value threshold of t dB.

The ranges of the given parameters are, for example, as follows: t≦0, Δ₁≧0, Δ_{OLPC-UP}>0, Δ_{OLPC-DOWN}>0, SIR−_{target}_{_{—}}ₘₐₓ≧SIR₁≧SIR_{target}_{_{—}}ₘᵢₙ and SIR_{target}_{_{—}}ₘₐₓ≧SIR₂≧SIR_{target}_{_{—}}_{min. The range of Δ}₂ is, for example, Δ_{OLPC-UP}≧Δ₂≧−Δ₁.

In an embodiment of the invention, when the coding block is decoded correctly and the sum of the differences between the measured SIR value (in dB) and the target SIR value (in dB) is smaller than the negative-value threshold of t dB, the target SIR is too high and the power of the soft handover user is controlled by another base station and the power control bits generated by this base station are of no use. Thus, the target SIR value should be reduced by step Δ₁, which is larger than Δ_{OLPC-DOWN}.

In the embodiment of the invention, when the coding block is decoded in error and the sum of the N samples of the differences between the measured SIR value (in dB) and the target SIR (in dB) is smaller than the negative value threshold of t dB, it is uncertain whether or not the target SIR value is too high. Thus, the target SIR value may be updated by step Δ₂, which is either negative (progressive), positive (conservative) or zero (neutral).

In an embodiment of the invention, the method may be used in association with Hybrid ARQ (Automatic Repeat reQuest). Let us assume that a base station of a radio system is under uplink soft handover situation. The base station compares the measured SIR value with the target SIR value and then stores samples, for example N samples, of the differences between the measured SIR values of the latest N power control groups (or slots) and the target SIR values of the latest N power control groups (or slots) in an initial Hybrid ARQ transmission frame. N is a positive integer, a system parameter. Herein, SIR_{target}(i) denotes the target SIR value (in dB) for the (i)th coding block at the base station. SIR_{target}_{_{—}}ᵢₙᵢₜ is the last target SIR value (in dB) for initial Hybrid ARQ transmissions. Each base station in the active set of the user equipment has its independent target SIR value, SIR_{target}(i), that is based on SIR_{target}_{_{—}}ᵢₙᵢₜ, quality of decoding of the (i-J)th coding block and the values of the N samples Δ_{SIR}(n)dB, where n=1, . . . ,N and the (i-J)th coding block is initial Hybrid ARQ transmission. The embodiments of the invention may be divided into hard-decision and soft-decision ones. The hard-decision method may be implemented as follows.

Let us assume, that K is the number of N samples, Δ_{SIR}(n), that satisfy a condition of Δ_{SIR}(n) being smaller than a threshold that is defined for the measured SIR value minus the target SIR value, t. We will denote this in the following way: Δ_{SIR}(n)<t. When adjusting the target SIR value, it is first detected whether K is higher or the same than the product of N and a fraction threshold of the slots, f, that is, whether K≧└N·f┘ and using the operator of └ ┘ results in a larger integral whose value is smaller than the processed real number. Let us assume, that J-1 is the decoding delay whose value depends on the implementation of the decoder.

If the (i)th coding block is a (L)^{th} retransmission coding block, SIR_{target}(i)=SIR_{target}_{_{—}}ᵢₙᵢₜ−Step_{L}.
Else, if K≧└N·f┘ and the (i-J)th coding block is decoded correctly, and SIR_{target}(i−1)−Δ₁≧SIR₁, then it can be determined that SIR_{target}(i)=SIR_{target}(i−1)−Δ₁;
Else, if K≧└N·f┘ and the (i-J)th coding block is decoded correctly, and SIR_{target}(i−1)−Δ₁<SIR₁, then SIR_{target}(i)=SIR₁;
Else, if K≧└N·f┘ and the (i-J)th coding block is decoded in error and SIR_{target}_{_{—}}ₘₐₓ≧SIR_{target}(i−1)+Δ₂21 SIR₂, then SIR_{target}(i)=SIR_{target}(i−1)+Δ₂;
Else, if K≧└N·f┘ and the (i-J)th coding block is decoded in error and SIR_{target}(i−1)+Δ₂>SIR_{target}_{_{—}}ₘₐₓ, then SIR_{target}(i)=SIR_{target}_{_{—}}ₘₐₓ;
Else, if K≧└N·f┘ and the (i-J)th coding block is decoded in error and SIR_{target}(i−1)+Δ₂<SIR₂, then SIR_{target}(i)=SIR₂;
Else, if K<└N·f┘ and the (i-J)th coding block is decoded in error and SIR_{target}(i−1)+Δ_{OLPC-UP<SIR}_{target}_{_{—}}ₘₐₓ, then SIR_{target}(i)=SIR_{target}(i−1)+Δ_{OLPC-UP};
Else, if K<└N·f┘ and the (i-J)th coding block is decoded in error and SIR_{target}(i−1)+Δ_{OLPC-UP}>SIR_{target}_{_{—}}ₘₐₓ, then SIR_{target}(i)=SIR_{target}_{_{—}}ₘₐₓ;
Else, if SIR_{target}(i−1)−Δ_{OLPC-DOWN}≧SIR_{target}_{_{—}}ₘᵢₙ, then SIR_{target}(i)=SIR_{target}(i−1)−Δ_{OLPC-DOWN;}
Else, SIR_{target}(i)=SIR_{target}_{_{—}}ₘᵢₙ.

The parameters used in the above example are as follows:
Step_{L} is the amount in decrease in the SIR target of the retransmission, and L is an ordinal number denoting the index of retransmission,
Δ_{OLPC-UP} is a SIR target up step of outer loop power control,
Δ_{OLPC-DOWN} is a SIR target down step of outer loop power control,
SIR_{target}_{_{—}}ₘₐₓ is a global maximum SIR target value,
SIR_{target}_{_{—}}ₘᵢₙ is a global minimum SIR target value,
t is a threshold that is defined for the measured SIR value minus the target SIR value,
f is the fraction threshold of the slots, in which the measured SIR value minus the target SIR value is smaller than the threshold, t,
SIR₁ is the local minimum target SIR value when the coding block is decoded correctly and the measured SIR value (in dB) is t dB smaller than the target SIR value (in dB) for the fraction of slots,
SIR₂ is the local minimum target SIR value when the coding block is decoded in error and the measured SIR value (in dB) is t dB smaller than the target SIR value (in dB) for the fraction of slots,
Δ₁ is the SIR target down step when the coding block is decoded correctly and the measured SIR value (in dB) is t dB smaller than the target SIR value (in dB) for the fraction f of slots,
Δ₂ is the SIR target up step when the coding block is decoded in error and the measured SIR value (in dB) is t dB smaller than the target SIR value (in dB) for the fraction f of slots.

The ranges of the given parameters may be as follows: t≦0, 1≧f>0, Δ₁≧0, Δ_{OLPC-UP}>0, Δ_{OLPC-DOWN}>0, SIR_{target}_{_{—}}ₘₐₓ≧SIR₁≧SIR_{target}_{_{—}}ₘᵢₙ and SIR_{target}_{_{—}}ₘₐₓ≧SIR₂≧SIR_{target}_{_{—}}ₘᵢₙ. The range of Δ₂ is, for example, Δ_{OLPC-UP}≧Δ₂≧−Δ₁.

In an embodiment of the invention, when the coding block is de-coded correctly and the measured SIR value is t dB smaller than the target SIR value for the fraction f of slots, the target SIR value is too high and the power of the soft handover user is controlled by another base station and the power control bits generated by this base station are of no use. Thus, the target SIR value should be reduced by step Δ₁, which is larger than Δ_{OLPC-DOWN}.

In an embodiment of the invention, when the coding block is de-coded in error and the measured SIR value is t dB smaller than the target SIR value for the fraction f of slots, it is uncertain whether the target SIR value is too high or not. Thus, the target SIR value may be updated by step Δ₂, which is either negative (progressive), positive (conservative) or zero (neutral). If step Δ₂ is zero, then the target SIR value may be unchanged.

Next, an embodiment of the soft-decision method is described. The soft-decision method uses the sum of ΔSIR(n),

$${\sum }_{n = 1}^{N} {Δ}_{SIR} ( n ) ,$$

for adjusting the target SIR value.

If the (i)th coding block is a (L)^{th} retransmission coding block, SIR_{target}(i)=SIR_{target}_{_{—}}ᵢₙᵢₜ−Step_{L}.
Else, if

$${\sum }_{n = 1}^{N} {Δ}_{SIR} ( n ) \leq t$$

and the (i-J)th coding block is decoded correctly, and SIR_{target}(i−1)−Δ₁≧SIR₁, then it can be determined that SIR_{target}(i)=SIR_{target}(i−1)−Δ₁;
Else, if

$${\sum }_{n = 1}^{N} {Δ}_{SIR} ( n ) \leq t$$

and the (i-J)th coding block is decoded correctly, and SIR_{target}(i−1)−Δ₁<SIR₁, then SIR_{target}(i)=SIR₁;
Else, if

$${\sum }_{n = 1}^{N} {Δ}_{SIR} ( n ) \leq t$$

and the (i-J)th coding block is decoded in error, and SIR_{target}_{_{—}}ₘₐₓ≧SIR_{target}(i−1)+Δ₂≧SIR₂, then SIR_{target}(i)=SIR_{target}(i−1)+Δ₂;
Else, if

$${\sum }_{n = 1}^{N} {Δ}_{SIR} ( n ) \leq t$$

and the (i-J)th coding block is decoded in error, and SIR_{target}(i−1)+Δ₂>SIR_{target}_{_{—}}ₘₐₓ, then SIR_{target}(i)=SIR_{target}_{_{—}}ₘₐₓ;
Else, if

$${\sum }_{n = 1}^{N} {Δ}_{SIR} ( n ) \leq t$$

and the (i-J)th coding block is decoded in error, and SIR_{target}(i−1)+Δ₂<SIR₂, then SIR_{target}(i)=SIR₂;
Else, if

$${\sum }_{n = 1}^{N} {Δ}_{SIR} ( n ) > t$$

and the (i-J)th coding block is decoded in error, and SIR_{target}(i−1)+Δ_{OLPC-UP}≦SIR_{target}_{_{—}}ₘₐₓ, then SIR_{target}(i)=SIR_{target}(i−1)+Δ_{OLPC-UP};
Else, if

$${\sum }_{n = 1}^{N} {Δ}_{SIR} ( n ) > t$$

and the (i-J)th coding block is decoded in error, and SIR_{target}(−1)+Δ_{OLPC-UP}≧SIR_{target}_{_{—}}ₘₐₓ, then SIR_{target}(i)=SIR_{taget}_{_{—}}ₘₐₓ;
Else, if SIR_{target}(i−1) Δ_{OLPC-DOwN}≧SIR_{target}_{_{—}}ₘᵢₙ, then SIR_{target}(i)=SIR_{target}(i−1)−Δ_{OLPC-DOWN};
Else, SIR_{target}(i)=SIR_{target}_{_{—}}ₘᵢₙ.

The parameters used in the above example are as follows:
Step₁ is the amount in decrease in the SIR target of the retransmission, and L is an ordinal number denoting the index of retransmission,
Δ_{OLPC-UP} is a SIR target up step of outer loop power control,
Δ_{OLPC-DOWN} is a SIR target down step of outer loop power control,
SIR_{target}_{_{—}}ₘₐₓ is a global maximum SIR target value,
SIR_{target}_{_{—}}ₘᵢₙ is a global minimum SIR target value,
t is a threshold that is defined for the measured SIR value minus the target SIR value,
SIR₁ is the local minimum target SIR value when the coding block is decoded correctly and the sum of the N samples of the differences between the measured SIR value (in dB) and the target SIR value (in dB) is smaller than the negative value threshold of t dB,
SIR₂ is the local minimum target SIR value when the coding block is decoded correctly and the sum of the N samples of the differences between the measured SIR value (in dB) and the target SIR value (in dB) is smaller than the negative value threshold of t dB,
Δ₁ is the SIR target down step when the coding block is decoded correctly and the sum of the N samples of the differences between the measured SIR value (in dB) and the target SIR value (in dB) is smaller than the negative value threshold of t dB,
Δ₂ is the SIR target up step when the coding block is decoded in error and the sum of the N samples of the differences between the measured SIR value (in dB) and the target SIR value (in dB) is smaller than the negative value threshold of t dB.

The ranges of the given parameters are, for example: t≦0, Δ₁≧0, Δ_{OLPC-UP}>0, Δ_{OLPC-DOWN}>0, SIR_{targe}_{_{—}}ₘₐₓ≧SIR₁≧SIR_{target}_{_{—}}ₘᵢₙ and SIR_{target}_{_{—}}ₘₐₓ≧SIR₂≧SIR_{target}_{_{—}}ₘᵢₙ. The range of Δ₂ is, for example, Δ_{OLPC-UP}≧Δ₂≧−Δ₁.

In an embodiment of the invention, when the coding block is de-coded correctly and the sum of the differences between the measured SIR value (in dB) and the target SIR value (in dB) is smaller than the negative value threshold of t dB, the target SIR is too high and the power of the soft handover user is controlled by another base station and the power control bits generated by this base station are of no use. Thus, the target SIR value should be reduced by step Δ₁, which is larger than Δ_{OLPC-DOWN}.

In the embodiment of the invention, when the coding block is de-coded in error and the sum of the N samples of the differences between the measured SIR value (in dB) and the target SIR (in dB) is smaller than the negative value threshold of t dB, it is uncertain whether the target SIR value is too high or not. Thus, the target SIR value may be updated by step Δ₂, which is either negative (progressive), positive (conservative) or zero (neutral).

After adjusting the target SIR value in 412, the process enters step 414, where the transmit power control command is provided to the user equipment. The embodiment of the method ends in 416.

In an embodiment of the invention, the method may be used in soft-handover, for example. Thus, a distributed outer loop power control without SIR value imbalance between primary and secondary base stations is provided. Such outer loop power control may serve both soft handover and non-soft handover users.

Even though the invention has been described above with reference to an example according to the accompanying drawings, it is clear that the invention is not restricted thereto but can be modified in several ways associated with data rate control within the scope of the appended claims.

1. A transmit power control method in a radio system supporting a use of coding blocks in communication between a base station and user equipment, the method including receiving coding blocks in at least one base station having a target signal-to-interference ratio (SIR) value, decoding the received coding blocks by the base station, measuring a SIR value, comparing, by the base station, the measured SIR value with the target SIR value of the base station, the method comprising:
determining a quality of a received coding block;
storing samples of differences between a measured SIR value and a target SIR value;
adjusting the target SIR value based on values of the samples of the differences between the measured SIR value and the target SIR value, and the quality of the received coding block; and
providing a transmit power control command based on the adjusted target SIR value to the user equipment.

2. The method of claim 1, the method further comprising adjusting the target SIR value by reducing the target SIR value by a predetermined down step value when decoding of the received coding block succeeds, and a difference of the differences between the measured SIR value and the SIR target value is smaller than a threshold that is defined for the measured SIR value minus the target SIR value for a fraction of time slots.

3. The method of claim 1, the method further comprising adjusting the target SIR value by reducing the target SIR value by a predetermined down step value when decoding of the received coding block succeeds, and a sum of the differences between the measured SIR value and the target SIR value is smaller than a negative value threshold that is defined for the measured SIR value minus the target SIR value.

4. The method of claim 2, wherein the adjusted target SIR value is greater than or equal to a local minimum target SIR value.

5. The method of claim 1, the method further comprising adjusting the target SIR value by adding a target SIR value up step value to the target SIR value when decoding of the received coding block fails and a difference of the differences between the measured SIR value and the SIR target value is smaller than a threshold that is defined for the measured SIR value minus the target SIR value for a fraction of time slots.

6. The method of claim 1, the method further comprising adjusting the target SIR value by adding a target SIR value up step value when decoding of the received coding block fails and a sum of the differences between the measured SIR value and the target SIR value is smaller than a negative value threshold that is defined for the measured SIR value minus the target SIR value.

7. The method of claim 5, wherein the up step target SIR value comprises a negative, positive or zero value.

8. The method of claim 5, wherein the adjusted target SIR value is greater than or equal to a local minimum target SIR value and smaller than or equal to a local maximum target SIR value.

9. The method of claim 1, the method further comprising adjusting the target SIR value by reducing the target SIR value by a predetermined target SIR down step value of outer loop power control when decoding of the received coding block succeeds and a difference of the differences between the measured SIR value and the SIR target value is larger than a threshold that is defined for the measured SIR value minus the target SIR value for a fraction of time slots.

10. The method of claim 1, the method further comprising adjusting the target SIR value by reducing the target SIR value by a predetermined target SIR down step value of outer loop power control when decoding of the received coding block succeeds and a sum of the differences between the measured SIR value and the target SIR value is larger than a negative value threshold that is defined for the measured SIR value minus the target SIR value.

11. The method of claim 9, wherein the adjusted target SIR value is greater than or equal to a global minimum target SIR value.

12. The method of claim 1, the method further comprising adjusting the target SIR value by adding a target SIR up step value of outer loop power control to the target SIR value when decoding of the received coding block fails and a difference of the differences between the measured SIR value and the SIR target is larger than a threshold that is defined for the measured SIR value minus the target SIR value for a fraction of time slots.

13. The method of claim 1, the method further comprising adjusting the target SIR value by adding a target SIR up step value of outer loop power control to the target SIR value when decoding of the received coding block fails and a sum of the differences between the measured SIR value and the target SIR value is smaller than a negative value threshold that is defined for the measured SIR value minus the target SIR value.

14. The method of claim 12, wherein the adjusted target SIR value is smaller than or equal to a local maximum target SIR value.

15. A radio having transmit power control, the radio uses coding blocks in communication between a transceiver and a receiver, and uses a target signal-to-interference ratio (SIR) value in transmit power control, the radio including decoding means for decoding a received coding block, measuring a SIR value and comparing means for comparing the measured SIR value with the target SIR value, the radio comprising:
determining means for determining a quality of a received coding block;
storing means for storing samples of differences between a measured SIR value and a target SIR value;
adjusting means for adjusting the target SIR value based on values of the samples of the differences between the measured SIR value and the target SIR value and the quality of the received coding block; and
providing means for providing a transmit power control command based on the adjusted target SIR value.

16. The radio of claim 15, wherein the adjusting means reduce the target SIR value by a predetermined down step value when decoding of the received coding block succeeds and a difference of the differences between the measured SIR value and the SIR target value is smaller than a threshold that is defined for the measured SIR value minus the target SIR value for a fraction of time slots of coding blocks.

17. The radio of claim 15, wherein the adjusting means reduce the target SIR value by a predetermined down step value when decoding of the received coding block succeeds and a sum of the differences between the measured SIR value and the target SIR value is smaller than a negative value threshold that is defined for the measured SIR value minus the target SIR value.

18. The radio of claim 16, wherein the adjusted target SIR value is greater than or equal to a local minimum target SIR value.

19. The radio of claim 15, wherein the adjusting means add a target SIR value up step value to the target SIR value when decoding of the received coding block fails and a difference of the differences between the measured SIR value and the SIR target value is smaller than a threshold that is defined for the measured SIR value minus the target SIR value for a fraction of time slots of coding blocks.

20. The radio of claim 15, wherein the adjusting means add a target SIR value up step value when decoding of the received coding block fails and a sum of the differences between the measured SIR value and the target SIR value is smaller than a negative value threshold that is defined for the measured SIR value minus the target SIR value.

21. The radio arrangement of claim 19, wherein the target SIR value up step value comprises a negative, positive or zero value.

22. The radio of claim 15, wherein the adjusting means limit the target SIR value to greater than or equal to a local minimum target SIR value and to smaller than or equal to a local maximum target SIR value.

23. The radio of claim 15, wherein the adjusting means reduce the target SIR value by a predetermined target SIR down step value of outer loop power control when decoding of the received coding block succeeds and a difference of the differences between the measured SIR value and the SIR target value is larger than a threshold that is defined for the measured SIR value minus the target SIR value for a fraction of time slots.

24. The radio of claim 15, wherein the adjusting means reduce the target SIR value by a predetermined target SIR down step of outer loop power control when decoding of the received coding block succeeds and a sum of the differences between the measured SIR value and the target SIR value is larger than a negative value threshold that is defined for the measured SIR value minus the target SIR value.

25. The radio of claim 23, wherein the adjusting means limit the target SIR value to greater than or equal to a global minimum target SIR value.

26. The radio of claim 15, wherein the adjusting means add a target SIR up step value of outer loop power control to the target SIR value when decoding of the received coding block fails and a difference of the differences between the measured SIR value and the SIR target value is larger than a threshold that is defined for the measured SIR value minus the target SIR value for a fraction of time slots.

27. The radio of claim 15, wherein the adjusting means add a target SIR up step value of outer loop power control to the target SIR value when decoding of the received coding block fails and a sum of the differences between the measured SIR value and the target SIR value is smaller than a negative value threshold that is defined for the measured SIR value minus the target SIR value.

28. The radio of claim 26, wherein the adjusting means limit the target SIR value to greater than or equal to a local maximum target SIR value.
